(19) United States
(12) Patent Application Publication
(10) Pub. No.: US 2015/0278927 A1
(43) Pub. Date: Oct. 1, 2015

(54) E-COMMERCE SUPPORT SYSTEM, E-COMMERCE SUPPORT METHOD, AND ADVERTISING MEDIUM

(71) Applicant: AliveCast Inc., Fukuoka (JP)

(72) Inventors: Osamu NAKAMURA, Fukuoka (JP); Tatsuhiko ITO, Fukuoka (JP)

(73) Assignee: AliveCast Inc.

(21) Appl. No.: 14/741,146

(22) Filed: Jun. 16, 2015

Related U.S. Application Data
(63) Continuation of application No. PCT/JP2013/083642, filed on Dec. 16, 2013.

(30) Foreign Application Priority Data
Dec. 17, 2012 (JP) 2012-274979

(51) Int. Cl. G06Q 30/06; G06Q 30/02

(52) U.S. Cl. CPC G06Q 30/0635; G06Q 30/0253

(57) ABSTRACT

An e-commerce support system includes an orderer terminal and an e-commerce support apparatus that are connected with a network. The orderer terminal reads commodity-service ID information from optically-readable information appearing on an advertising medium, and transmits the information to a network address indicating the e-commerce support apparatus. The apparatus then transmits order screen information to the orderer terminal.

### CROSS-REFERENCE TO RELATED APPLICATIONS

This application is a continuation application of International Patent Application No. PCT/JP2013/083642 filed on Dec. 16, 2013, which claims priority to Japanese Patent Application No. 2012-274979 filed on Dec. 17, 2012 in Japan, the entire contents of which are incorporated by reference in their entirety herein.

### BACKGROUND OF INVENTION

1. Field of the Invention

The present invention relates to an e-commerce support system, an e-commerce support method, and an advertising medium that allow an orderer to order commodities or services by operating a terminal and reading optically-readable information.

2. Background Art

Techniques associated with electronic commerce (or e-commerce) have been developed to allow an orderer to order items by operating his or her terminal (orderer terminal) and reading optically-readable information appearing on an advertising medium, such as a billboard on a street, a poster, an advertisement on train, and a television screen. One such technique is described in Japanese Unexamined Patent Application Publication No. 2003-85387 (Patent Literature 1).

A method of e-commerce described in Patent Literature 1 includes reading image information, such as a two-dimensional barcode, with a mobile information processing device including a two-dimensional code reader, a two-dimensional code decoder, and a two-dimensional code converter, and connecting the device to an e-commerce server. This method allows a business operator, which is authorized to control the e-commerce, to enter control information in a license registry checking server with its terminal. The business operator can thus control access to an e-commerce server.

With the method of e-commerce described in Patent Literature 1, a user acquires network information about an access destination (e.g., URL) by reading image information (two-dimensional code) provided by a business operator on printed matter or on an electronic display with his or her mobile information processing device, and accesses the e-commerce server installed at the business operator. Although the operation is simplified, this operation is similar to manually inputting the URL into a browser to access the server.

At the accessed site where items are sold, the user places an intended item into a cart and settles the payment. This operation is complicated.

### SUMMERY OF INVENTION

The present invention is directed to an e-commerce support system, an e-commerce support method, and an advertising medium that allow an orderer to order commodities or services easily.

A first aspect of the present invention provides an e-commerce support system including an orderer terminal operable by an orderer and an e-commerce support apparatus. The orderer terminal and the e-commerce support apparatus are connected with a network. The orderer terminal includes a reader unit, a viewer unit, and a request notification unit. The reader unit reads commodity-service ID information from optically-readable information appearing on an advertising medium, and transmits, together with orderer ID information, the commodity-service ID information to a network address indicating the e-commerce support apparatus in the network. The commodity-service ID information identifies a commodity or service. The orderer ID information identifies the orderer who operates the orderer terminal. The network address is set in the orderer terminal. The viewer unit receives order screen information transmitted from the e-commerce support apparatus based on the commodity-service ID information, and displays the order screen information on a display unit. The request notification unit transmits an order request notification to the e-commerce support apparatus in response to an ordering operation that is performed with an input unit using the order screen information on the display unit. The e-commerce support apparatus includes a storage unit, a screen transmission unit, and an order processing unit. The storage unit stores the order screen information associated with the commodity-service ID information. The screen transmission unit reads the order screen information from the storage unit based on the commodity-service ID information transmitted from the orderer terminal, and transmits the order screen information to the orderer terminal. The order processing unit enters an order for the commodity or service identified by the commodity-service ID information in accordance with the order request notification transmitted from the orderer terminal.

A second aspect of the present invention provides an e-commerce support method implemented by an orderer terminal and an e-commerce support apparatus. The orderer terminal and the e-commerce support apparatus are connected with a network. The method includes processes performed by a reader unit in the orderer terminal, a screen transmission unit in the e-commerce support apparatus, a viewer unit in the orderer terminal, a request notification unit in the orderer terminal, and an order processing unit in the e-commerce support apparatus. In these processes, the reader unit reads commodity-service ID information from optically-readable information appearing on an advertising medium, and transmits, together with orderer ID information for identifying an orderer who operates the orderer terminal, the commodity-service ID information to a network address indicating the e-commerce support apparatus in the network. The network address is set in the orderer terminal. The screen transmission unit reads order screen information from a storage unit of the e-commerce support apparatus based on the commodity-service ID information transmitted from the orderer terminal, and transmits the order screen information to the orderer terminal. The viewer unit receives the order screen information transmitted from the e-commerce support apparatus based on the commodity-service ID information, and displays the order screen information on a display unit of the orderer terminal. The request notification unit transmits an order request notification to the e-commerce support apparatus in response to an ordering operation that is performed with an input unit using the order screen information on the display unit. The order processing unit enters an order for a commodity or service identified by the commodity-service ID information in accordance with the order request notification transmitted from the orderer terminal.

In the system or with the method according to the above aspects of the present invention, the reader unit reads commodity-service ID information from optically-readable information appearing on an advertising medium with the orderer terminal, and transmits the read information to a network address indicating the e-commerce support apparatus in the network, which has been set in the orderer terminal. As a result, the viewer unit displays the order screen information transmitted from the e-commerce support apparatus. The orderer can then order a commodity or service based on the order screen information. This eliminates the complicated operation of, for example, placing an intended item into a cart and completing the order.

The commodity includes any item that can be requested for delivery. Examples include either paid or free items, samples, and brochures. The service refers to receiving either a paid or free service. Examples include services purchased by reading optically-readable information provided by a seller (provider) at locations where the services are offered, and also include accommodation coupons, voucher tickets or coupons used for drinking and eating, and voucher tickets or entry tickets for facilities. The payment for a purchased commodity or a purchased service includes payment made when the commodity or service is ordered, instead of when the commodity or service is reserved. Alternatively, the payment may be made when the commodity or service is provided. In this case, the commodity or service is simply reserved when it is ordered.

In some embodiments, the e-commerce support apparatus further includes a history management unit. The history management unit stores, as order history information, the commodity-service ID information identifying the commodity or service ordered with the order request notification transmitted from the orderer terminal into the storage unit, and reads the order history information from the storage unit in accordance with a request to display a history transmitted from the orderer terminal, and transmits history screen information listing the order history information to the orderer terminal. The viewer unit in the orderer terminal receives the history screen information from the e-commerce support apparatus and displays an order history screen showing the received history screen information on the display unit.

The viewer unit can display previously ordered commodities or services in an order history screen appearing on the orderer terminal. This allows the ordered commodities or services to be identified easily.

In some embodiments, the request notification unit in the orderer terminal transmits an order request notification to the e-commerce support apparatus in response to a history selection operation that is performed with the input unit using the history screen information on the display unit and an ordering operation that is performed using the order history information selected by the history selection operation.

The request notification unit in the orderer terminal enables easy reordering from the order history screen. This enhances convenience for the orderer, and promotes sales for the seller.

In some embodiments, the orderer terminal further includes an optical information generation unit. The optical information generation unit displays optically-readable information on the display unit based on commodity-service ID information included in the order history information transmitted from the history management unit.

The orderer may show optically-readable information appearing on the display unit to, for example, an acquaintance. The acquaintance may then operate his or her orderer terminal to read the optically-readable information. In this manner, the acquaintance may order the commodity or service ordered by the orderer. The orderer can recommend his or her previously ordered commodities or services easily to friends or acquaintances.

In some embodiments, when the history management unit in the e-commerce support apparatus transmits the order history information to the orderer terminal, the history management unit uses, as the order history information, commodity-service ID information updated from the commodity-service ID information used when the order is placed.

The e-commerce support apparatus uses the updated commodity-service ID information, and thus can determine whether the ordered commodity or service constitutes the first order, or the commodity or service is reordered using the order history information.

In some embodiments, when the history selection operation performed with the input unit using the history screen information indicates a sample, the history management unit in the e-commerce support apparatus transmits commodity-service ID information indicating that the commodity or service is a paid item based on the commodity-service ID information used when the order is placed. When the orderer tries a sample and likes it, the orderer can purchase a paid item of the sample.

In some embodiments, when the history selection operation performed with the input unit using the history screen information indicates a set of samples, the history management unit transmits commodity-service ID information indicating that the commodity or service is one or more of a plurality of paid items corresponding to the samples in the set based on the commodity-service ID information used when the order is placed.

When the orderer tries a set of samples and likes one or more of the samples, the orderer can order items of such one or more samples separately.

In some embodiments, the request notification unit in the orderer terminal transmits an approval request notification indicating a request to order a commodity or service to another orderer terminal in response to an ordering operation that is performed with the input unit using order screen information displayed on the display unit, and transmits an order request notification to the e-commerce support apparatus in response to an ordering operation performed to approve an order for the commodity or service in response to the approval request notification.

A person unable to make payment of e-commerce can ask another person to make the payment. This widens the range of orderers, and thus increases the sales of commodities or services further.

In some embodiments, the order processing unit in the e-commerce support apparatus reads effective period information indicating an effective period of the order for the commodity or service from the storage unit based on the commodity-service ID information transmitted from the orderer terminal, and notifies the orderer terminal that the order indicated by the order request notification transmitted from the orderer terminal is ineffective when a time and date at which the orderer operating the orderer terminal has attempted to place the order fails to be within the effective period indicated by the effective period information.

If the orderer mistakenly places an order for an expired commodity or service by using a fryer or a poster left after its expiry period, the order processing unit checks the effective period information, and prevents the commodity or service from being ordered mistakenly.

In some embodiments, the order processing unit in the e-commerce support apparatus reads effective period information indicating a time period for a special price of the commodity or service from the storage unit based on the commodity-service ID information transmitted from the orderer terminal, and the screen transmission unit reads special price information indicating a special price of the commodity or service from the storage unit based on the commodity-service ID information, and transmits order screen information including the special price corresponding to the commodity-service ID information to the orderer terminal when a time and date at which the orderer operating the orderer terminal has attempted to place the order is within the time period indicated by the effective period information.

When the seller intends to offer a commodity or service at a special price in a predetermined time period indicated by effective period information, the order processing unit checks the effective period information and can offer the commodity or service at the special price when the order has been placed within the time period indicated by the effective period information.

In some embodiments, the e-commerce support apparatus further includes an optical information generation unit. The optical information generation unit generates optically-readable information to appear on an advertising medium based on the commodity-service ID information in such a manner that the optically-readable information includes medium ID information for identifying the advertising medium.

Such medium ID information is assigned to the advertising media in accordance with its type. This allows statistical analysis of the advertisement ID information indicating advertising media used for every order. Such analysis can determine the advertising media that contribute to frequent orders.

A third aspect of the present invention provides an advertising medium including optically-readable information indicating a network address to be accessed to acquire an orderer program when no orderer program has been installed in the orderer terminal included in the e-commerce support system according to any one of the above aspects of the present invention. The program is installable on a computer to enable the computer to function as a reader unit, a viewer unit, and a request notification unit. The reader unit reads commodity-service ID information from optically-readable information appearing on an advertising medium, and transmits, together with orderer ID information, the commodity-service ID information to a network address indicating the e-commerce support apparatus in the network. The commodity-service ID information identifies a commodity or service. The orderer ID information identifies the orderer who operates the orderer terminal. The network address is set in the orderer terminal. The viewer unit receives order screen information transmitted from the e-commerce support apparatus based on the commodity-service ID information, and displays the order screen information on a display unit. The request notification unit transmits an order request notification to the e-commerce support apparatus in response to an ordering operation that is performed with an input unit using the order screen information on the display unit.

The advertising medium according to the third aspect of the invention enables a computer, on which no orderer program has been installed, to read a two-dimensional barcode including an address where an orderer program is to be provided to the computer. This allows the orderer program to be acquired easily and be installed.

In some embodiments, the commodity-service ID information constitutes a part of the network address to be accessed to acquire the orderer program. The accessed address includes the commodity-service ID information, and thus has no access destination. This information, or determining whether the accessed address has an access destination, can be used to determine whether the address has been accessed by reading optically-readable information under the orderer program. This allows easy determination of whether the access comes from a computer on which no orderer program has been installed.

One or more embodiments of the present invention eliminates the complicated operations of, for example, placing an intended item into a cart and completing the order, and allows an orderer to easily order a commodity or service.

Other aspects and advantages of the invention will be apparent upon reading the following description, the drawings, and the claims.

### BRIEF DESCRIPTION OF THE DRAWINGS

FIG. 1 is a diagram describing an e-commerce support system according to embodiments of the present invention;

FIG. 2 is a block diagram of an orderer terminal operable by an orderer in the e-commerce support system shown in FIG. 1;

FIG. 3 is a block diagram of an e-commerce support apparatus installed at an e-commerce operator in the e-commerce support system shown in FIG. 1;

FIG. 4 is a diagram describing the procedure for ordering a commodity or service in the e-commerce support system shown in FIG. 1;

FIG. 5 shows an example of an order screen;

FIG. 6 is a diagram describing the procedure for ordering a commodity or service that is offered at a special price in the e-commerce support system shown in FIG. 1;

FIG. 7 is a diagram describing the procedure for cancelling an order for a commodity or service in the e-commerce support system shown in FIG. 1;

FIG. 8A shows an example of an order history screen;

FIG. 8B shows an example of an operational screen;

FIG. 9 shows an example of a two-dimensional barcode displayed using the order history screen;

FIG. 10 is a diagram describing the procedure of reordering using the order history screen in the e-commerce support system shown in FIG. 1;

FIG. 11A show another example of the order history screen;

FIG. 11B shows another example of the operational screen;

FIG. 12 is a diagram describing the procedure for requesting payment from a person unable to make payment of e-commerce to a person able to make payment in the e-commerce support system shown in FIG. 1;

FIG. 13A shows another example of the order screen;

FIG. 13B shows an example of an approval screen;

FIG. 14 shows an example of an order screen for requesting a brochure;

FIG. 15 shows an example of an order screen for requesting a sample;

FIG. 16A shows an example of an order screen for requesting a set of samples;

FIG. 16B shows an example of an order history screen displayed when a set of samples are ordered;

FIG. 17 shows an example of an operational screen displayed when one or more individual items in the sample set are to be ordered;

FIG. 18A shows a list display screen listing the individual items in the sample set;

FIG. 18B shows an order screen for purchasing a paid item of an ordered sample;

FIG. 19 is a diagram describing the system for acquiring an installation program when no orderer program has been installed on a mobile phone;

FIG. 20 shows an example of barcode information;

FIG. 21 is a block diagram of an information guidance apparatus shown in FIG. 19; and

FIG. 22 shows an example of a guidance screen for an installation program.

### DETAILED DESCRIPTION

### Embodiments

An e-commerce support system according to embodiments of the present invention will now be described with reference to the drawings.

An e-commerce support system 10 according to the present embodiment allows a user to easily order a commodity or service by reading optically-readable information appearing on an advertising medium. The e-commerce support system 10 includes an orderer terminal 20, which is operated by an orderer, and an e-commerce support apparatus 30, which is installed at an e-commerce operator. The orderer terminal 20 and the e-commerce support apparatus 30 are connected to each other with a network, which is for example the Internet W.

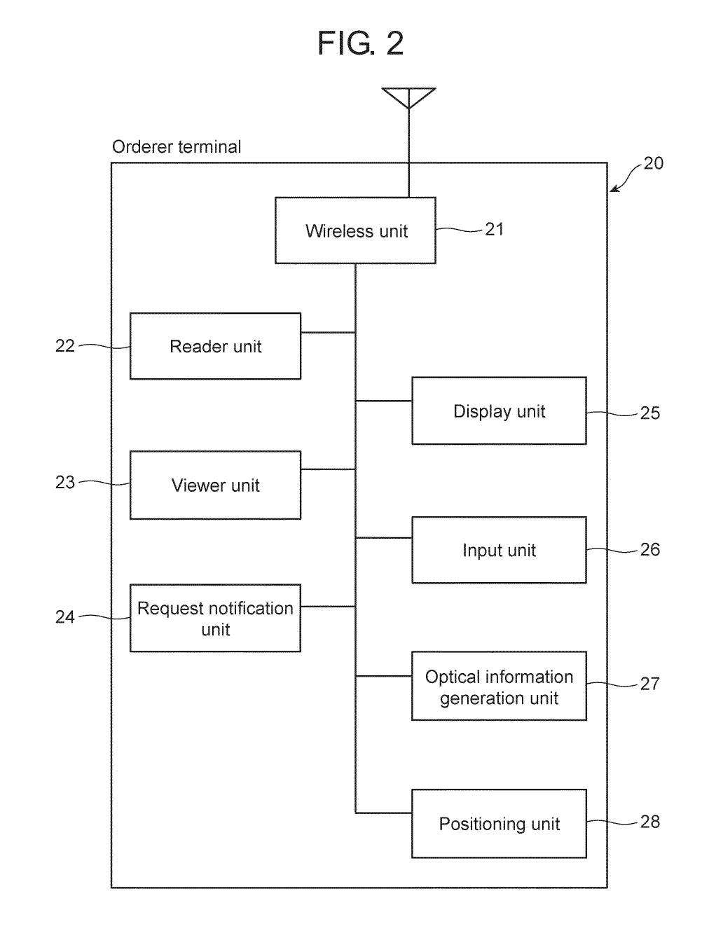

The orderer terminal 20 is a smartphone, or a mobile terminal with telephone function, Internet access, and the capability of reading a two-dimensional barcode, which is an example of optically-readable information. In the present embodiment, an ordering program usable by an orderer (hereafter, orderer program) is installed on the smartphone, which is an example of a computer. The program enables the smartphone to function as the orderer terminal 20. FIG. 2 shows the main components of the smartphone that functions as the orderer terminal 20, and does not show other functions of the smartphone such as telephone function.

As shown in FIG. 2, the orderer terminal 20 includes a wireless unit 21, a reader unit 22, a viewer unit 23, a request notification unit 24, a display unit 25, an input unit 26, an optical information generation unit 27, and a positioning unit 28.

The wireless unit 21 wirelessly communicates with a relay or a base station accessible to the Internet W, and outputs data to the Internet W or receives input data from the Internet W.

The reader unit 22 reads barcode information including commodity-service ID information from optically-readable information appearing on an advertising medium, and transmits the barcode information to a network address indicating the e-commerce support apparatus 30 in the network, together with orderer ID information for identifying an orderer who operates the orderer terminal 20 and positional information including the longitude and latitude at which the terminal 20 is positioned. The network address is, for example, an IP address or a URL in the network that is the Internet W. The IP address or the URL is automatically set in the terminal (orderer terminal 20) when an orderer program is installed. The network address is stored in the reader unit 22. The network address indicating the e-commerce support apparatus 30 in the network may be stored in a functional unit other than the reader unit 22, or may be stored in a storage unit (not shown).

The viewer unit 23 receives screen information from the e-commerce support apparatus 30, and displays the information on the display unit 25.

In response the orderer's operation of pressing a button on the display screen displayed by the viewer unit 23 based on the screen information, the request notification unit 24 transmits a request notification in accordance with the function of the pressed button to the e-commerce support apparatus 30.

The display unit 25 is, for example, a liquid crystal display (LCD) or an organic electroluminescence (EL) display for displaying data. The input unit 26 is, for example, a touch panel mounted on the front surface of the display unit 25.

The optical information generation unit 27 generates optically-readable information based on commodity-service information transmitted from the e-commerce support apparatus 30, and displays the generated information on the display unit 25.

The positioning unit 28 outputs information about the position of the orderer terminal 20, which is positional information indicating the longitude and the latitude. The positioning unit 28 is, for example, a global positioning system (GPS). The positioning unit 28 may be any other device that can determine the position of the orderer terminal 20. For example, the positioning unit 28 may be a device that determines the position of a mobile phone by using electric waves received at a plurality of base stations installed for mobile phones. The positional information may not be limited to two-dimensional information, or to the information indicating the longitude and the latitude. The positional information may further include information indicating the height.

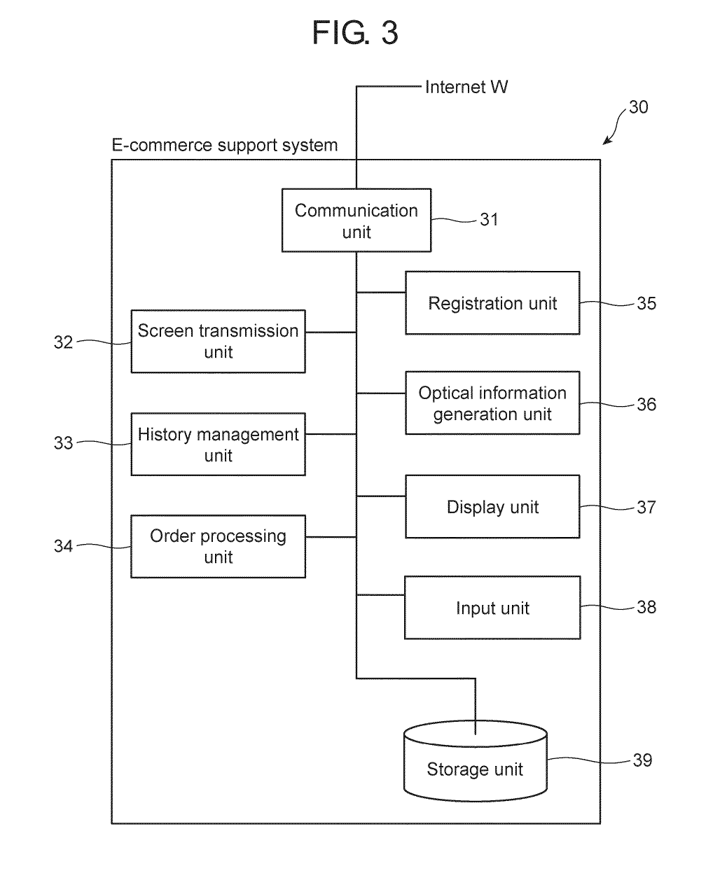

As shown in FIG. 3, the e-commerce support apparatus 30 is a server (computer) storing information about commodities or services that are sold by a seller. The present embodiment uses an e-commerce support program installed and operated on this computer. The computer thus functions as the e-commerce support apparatus 30.

The e-commerce support apparatus 30 includes a communication unit 31, a screen transmission unit 32, a history management unit 33, an order processing unit 34, a registration unit 35, an optical information generation unit 36, a display unit 37, an input unit 38, and a storage unit 39.

The communication unit 31 outputs transmission data to the Internet W or receives input reception data from the Internet W.

The screen transmission unit 32 reads display screen information from the storage unit 39 in accordance with a request from the orderer terminal, and transmits the information to the orderer terminal 20.

The history management unit 33 stores order history information indicating ordered commodities and services into the storage unit 39. The history management unit 33 reads order history information from the storage unit 39 in accordance with a history display request notification transmitted from the orderer terminal 20, and transmits history screen information listing the orders indicated by the order history information to the orderer terminal 20.

The order processing unit 34 processes the payment for an ordered commodity or an ordered service based on payment information indicating a payment method registered with the storage unit 39.

The registration unit 35 processes registrations including member registration of an orderer, registration of a seller, and registration of commodities and services.

When the seller creates an advertisement, the optical information generation unit 36 generates optically-readable information for a commodity or service to appear on the advertisement medium. The optically-readable information is generated based on the registration process for registering the commodity or service performed by the registration unit 35. The optically-readable information may be a monochrome one-dimensional or two-dimensional barcode, or a colored one-dimensional or two-dimensional barcode carrying more information, or a dot pattern coded using microdots. In the present embodiment, the optically-readable information is a QR code (trademark), which is an example of a monochrome two-dimensional barcode.

The display unit 37 is, for example, a liquid crystal display (LCD), an organic EL display, or a cathode-ray tube (CRT) for displaying data. The input unit 38 is, for example, a keyboard or a mouse.

The storage unit 39 stores personal information about an orderer registered as a member, seller information about a seller who sells commodities or services, commodity-service information about commodities or services to be sold, order history information about ordered commodities or services, and screen information.

The personal information about the orderer includes registered information input during member registration, which is information about the orderer's name, address, phone number, address for delivery, payment, and e-mail address. The personal information also includes orderer ID information, which is assigned by the registration unit 35 when the registration is complete. These items of personal information are associated with one another.

The payment information includes information about a credit card issued by a credit card company, or information about the name of a cardholder, the card number, and the expiry date.

The seller information includes company information input during company registration, which is information about the company name, the address, the name of the representative, and the person in charge. The seller information also includes company ID information for identifying the seller, which is assigned by the registration unit 35 when the registration is complete. These items of seller information are associated with one another.

The information about the person in charge includes information about the person's department, e-mail address, and phone number. These items of information are associated with one another.

The commodity-service information includes information input when the commodity or service is registered. The commodity-service information includes information about the name of the commodity or service, an image file showing the commodity or showing the contents of the service, the commodity or service description, the price, the effective period, partner information indicating a partner company for the seller, and advertisement ID information for identifying an advertising medium. The commodity-service information also includes commodity-service ID information for identifying the commodity or service, which is assigned by the registration unit 35 when the registration is complete. These items of commodity-service information are associated with one another.

The effective period information indicates an effective period during which the commodity or service can be ordered. The effective period is defined by the time and date at which the order for the commodity or service becomes effective (information about the starting time and date of the effective period) and the time and date at which the order becomes ineffective (information about the time and date at which the effective period ends). When the starting time and date of the effective period indicated by the effective period information is before the current time, the order is effective. In this case, the effective period information indicates that the current time is within the effective period.

The order history information includes information about the commodity or service indicated by a two-dimensional barcode read when the order is placed, the order date and time, the positional information, and the personal information of the orderer. These items of order history information are associated with one another.

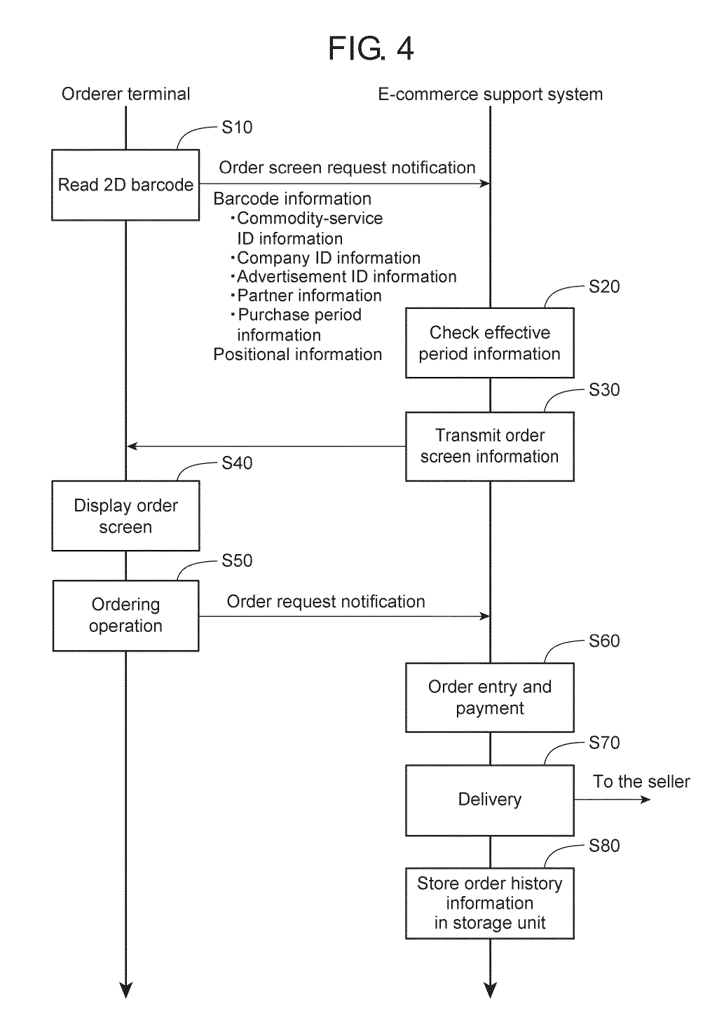

The operation and the use of the e-commerce support system according to the embodiment of the present invention will now be described with reference to FIG. 4.

In the present embodiment, the orderer has completed his or her member registration. The seller has completed its company registration as well as its commodity and/or service registration.

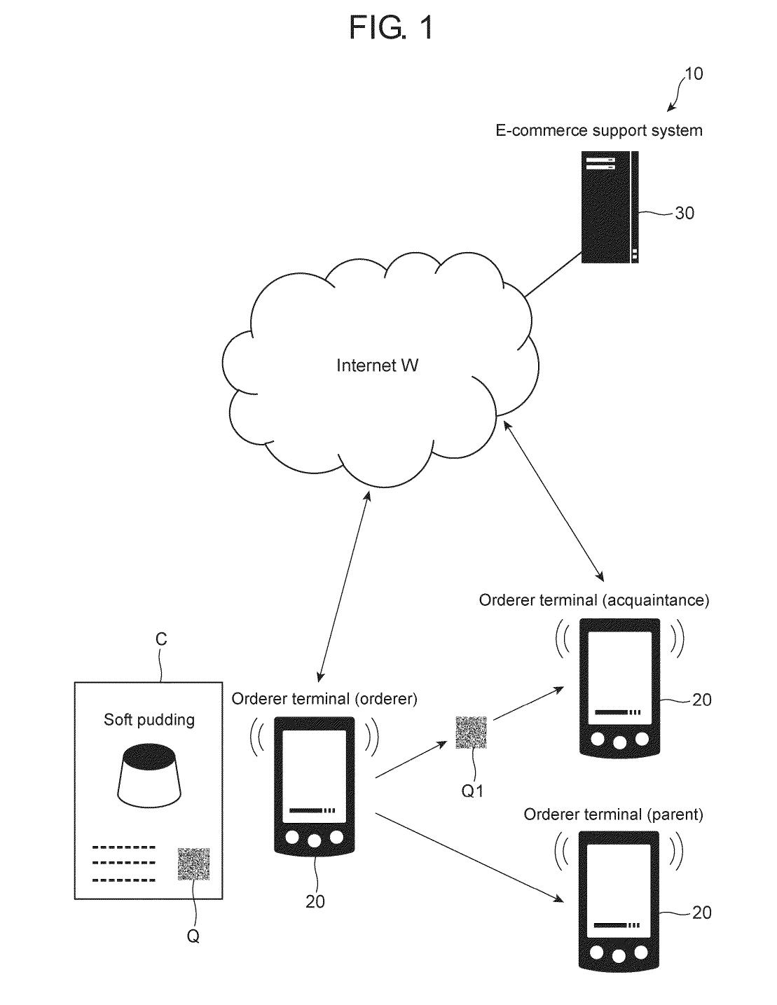

For example, the orderer who obtains and sees a fryer C shown in FIG. 1 may have interest in a commodity on the fryer C, which is a pudding, and intends to order the commodity. The orderer points the orderer terminal 20 to a two-dimensional barcode Q appearing on the fryer C, and reads the barcode Q with the orderer terminal 20.

In the orderer terminal 20, the reader unit 22 reads and analyzes the two-dimensional barcode Q, which has been generated by the optical information generation unit 36.

The two-dimensional barcode Q is an image pattern generated by the optical information generation unit 27. The two-dimensional barcode Q is printed on the fryer C. The two-dimensional barcode Q contains barcode information including commodity-service ID information, company ID information, advertisement ID information, and partner information.

The reader unit 22 transmits information obtained by analyzing the two-dimensional barcode Q, together with the orderer ID information for identifying the orderer who operates the orderer terminal 20 and the positional information indicating the longitude and the latitude of the orderer terminal 20 input by the positioning unit 28, to the network address indicating the e-commerce support apparatus 30 in the network via the wireless unit 21 (step S10).

The e-commerce support apparatus 30 receives an order screen request notification transmitted by the orderer terminal 20, which has read the two-dimensional barcode Q. In response to the order screen request notification, the order processing unit 34 first checks the effective period information (step S20). To obtain this effective period information, the order processing unit 34 searches the storage unit 39 for effective period information associated with the commodity-service ID information transmitted from the orderer terminal 20. The order processing unit 34 checks the effective period information by determining whether an order from the orderer terminal 20 has been placed later than the starting time and date of the effective period and before the end time and date of the effective period indicated by the effective period information.

When determining that the time and date at which the orderer who has attempted to place the order by operating the orderer terminal 20 fails to be within the effective period indicated by the effective period information, the order processing unit 34 transmits this determination result to the orderer terminal 20. In one example, the order processing unit 34 transmits a notification screen with a message indicating that the commodity or service identified by the commodity-service ID information carried by the two-dimensional barcode Q cannot be ordered.

When the time and the date at which the e-commerce support apparatus 30 receives the order screen request notification is within the effective period, the screen transmission unit 32 reads order screen information from the storage unit 39 based on the commodity-service ID information transmitted from the orderer terminal 20, and transmits the read information to the orderer terminal 20 (step S30).

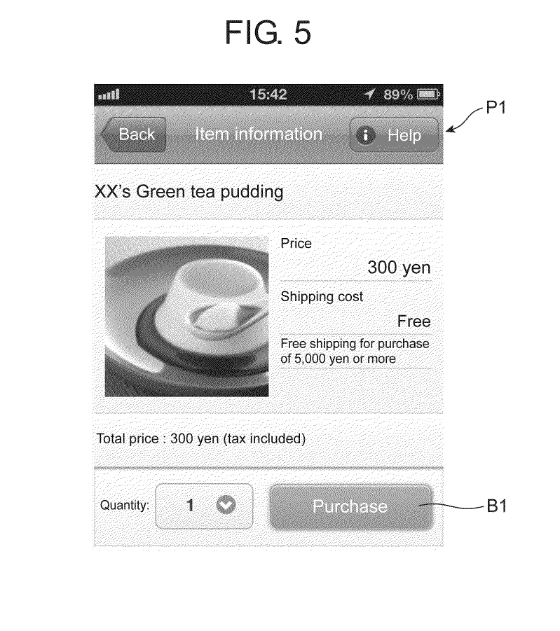

In the orderer terminal 20, the viewer unit 23 receives the order screen information for the commodity or service identified by the commodity-service ID information from the e-commerce support apparatus 30, and displays the received information on the display unit 25 (step S40). FIG. 5 shows an order screen P1 appearing on the display unit 25 based on the order screen information. The order screen information simply carries the display items (e.g., an image file representing a photograph of the commodity, commodity description, price information, and text data for displaying an order button), and contains no screen data. This reduces the amount of information to be transmitted, and allows the viewer unit 23 to display the order screen quickly.

FIG. 5 shows an example of the order screen P1 used to order a commodity, which is a pudding.

The orderer sees the photograph, description, and price of the item included in the order screen P1 on the display unit 25, and intends to order this item. To perform an ordering operation, the orderer designates the quantity, and presses the “Purchase” button B1 appearing in the order screen P1 by tapping the button. In response to this ordering operation, the request notification unit 24 transmits an order request notification to the e-commerce support apparatus 30 (step S50).

In the e-commerce support apparatus 30, the order processing unit 34 performs an order entry process for entering an order for the pudding indicated by the commodity-service ID information in accordance with the order information carried by the order request notification transmitted from the orderer terminal 20, and processes its payment based on payment information corresponding to the orderer ID information (step S60). For example, the order processing unit 34 transmits a payment notification to a server managed by a credit card company.

In the order entry process, the order processing unit 34 notifies the seller that an order for the pudding has been entered based on the order information. More specifically, the order processing unit 34 sends an e-mail message to the person in charge at the seller based on the e-mail address information. The text of the e-mail message contains the item name or the pudding (name information), commodity-service ID information identifying the pudding, quantity information indicating the ordered quantity of the pudding, the orderer name information, and delivery address information, together with information about the person in charge. The seller performs a delivery process based on this e-mail message (step S70).

The history management unit 33 stores barcode information including commodity-service ID information indicating the commodity or service ordered with the order request notification from the orderer terminal 20 (pudding in this example) and the ordered time and date information indicating the time and date of the order into the storage unit 39 as order history information (step S80).

The two-dimensional barcode carries advertisement ID information, in addition to the commodity-service ID information identifying the commodity or service. The history management unit 33 stores advertisement ID information for every order into the storage unit 39. Such advertisement ID information can be used by the seller to statistically analyze the advertising media with frequent orders for the commodity or service, among different advertising media including posters, fryers, newspapers, magazines, and television broadcasts.

The orderer terminal 20 transmits its positional information to the e-commerce support apparatus 30 for every order. Such positional information allows statistical analysis of regions with frequent orders for the commodity or service, among different advertising media including posters and fryers posted and distributed in various regions. The positional information can be used to analyze, for example, the regions in which posted posters or distributed fryers are most effective.

The order processing unit 34 may identify the position at which each order has been placed based on the positional information, and may enable orders in some regions but disable orders in other regions to limit the regions in which the commodity or service can be ordered

The two-dimensional barcode carries partner information. The partner information can be used to offer a predetermined proportion of the sales for the commodity or service to the partner company of the seller as a part of the payment or as an incentive fee. For example, the partner company may be a printing company that creates a fryer or a poster. The printing company may receive a part of the payment or as an incentive fee in accordance with the sales. This encourages the printing company to create a more effective fryer or poster, and enables the seller to create a fryer or poster at a lower cost in return for such payment made in accordance with the sales.

The storage unit 39 stores the commodity-service information including effective period information. If the orderer mistakenly places an order for an expired commodity or service by using a fryer or a poster left after its expiry period, the order processing unit 34 checks the effective period information and prevents the order from being placed mistakenly. When the fryer C is distributed to the orderer for an advance notice of a commodity or service before the starting time and date of the effective period, this effective period information can be used to prevent the commodity or service from being sold mistakenly.

This method of limiting the selling period is useful for commodities or services to be offered only within a limited period of time, such as tickets for concerts or stage performance, tickets for exhibitions or expositions, or items available for a limited time only.

The two-dimensional barcode may include effective period information. This eliminates the operation of the e-commerce support apparatus 30 for searching the storage unit 39 for the commodity-service ID information and obtaining effective period information associated with the commodity-service ID information, and thus reduces the processing load of the e-commerce support apparatus 30.

In the above example, the time and date at which the e-commerce support apparatus 30 receives the order screen request notification is used as the time and date at which the orderer places the order. Alternatively, the processing in step S20 for checking the effective period information may be performed before step S60. In this case, the notification screen indicating that the commodity or service cannot be ordered is transmitted when the screen transmission unit 32 transmits the order screen information to the orderer terminal 20 and the orderer performs an operation to purchase the commodity or service. The order screen information may further include an effective period during which the commodity or service can be purchased.

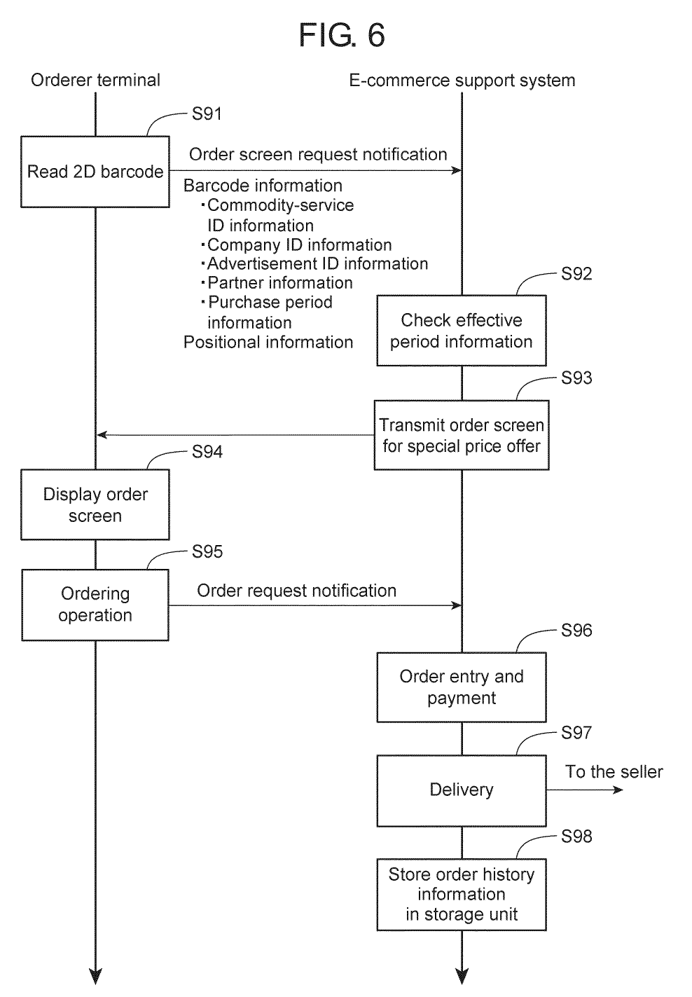

The operation of the e-commerce support apparatus 30 for offering a commodity or service at a special price based on effective period information will now be described with reference to FIG. 6.

To set an effective time period indicated by the effective period information, the time and date at which an order becomes effective (the starting time and date of the effective period) and the time and date at which the order becomes ineffective (the end time and date of the effective period) are set at different times on the same date. The effective period may be set every day by using a wild-card operator that returns the time period independently of the date. The effective period may be set only on predetermined days of a week, for example, on Saturday and Sunday, by setting the days of a week in the effective period information.

The orderer sees the fryer C indicating that a commodity or service is offered at a special price for the set time period. The orderer then points the orderer terminal 20 to the two-dimensional barcode Q and reads the two-dimensional barcode Q on the fryer C with the orderer terminal 20.

In the orderer terminal 20, the reader unit 22 transmits information obtained by analyzing the two-dimensional barcode Q to the address of the e-commerce support apparatus 30 in the network via the wireless unit 21, together with the orderer ID information and the positional information (step S91).

The e-commerce support apparatus 30 receives an order screen request notification from the orderer terminal 20. The order processing unit 34 checks the effective period information (step S92).

When the order processing unit 34 determines that the time and date at which the orderer has attempted to place the order by operating the orderer terminal 20 fails to be within the effective period indicated by the effective period information, the screen transmission unit 32 reads commodity-service information including price information indicating the normal price of the commodity or service from the storage unit 39 based on the commodity-service ID information, and transmits order screen information for displaying this commodity-service information to the orderer terminal 20.

When the order processing unit 34 determines that the time and date at which the orderer has attempted to place the order by operating the orderer terminal 20 is within the effective period indicated by the effective period information, the screen transmission unit 32 reads commodity-service information including price information indicating the special price of the commodity or service from the storage unit 39 based on the commodity-service ID information, and transmits the order screen information for displaying this commodity-service information to the orderer terminal 20 (step S93).

In the orderer terminal 20, the viewer unit 23 receives the order screen information indicating the commodity or service identified by the commodity-service ID information from the e-commerce support apparatus 30, and displays the received information on the display unit 25 (step S94). The order screen information appearing on the display unit 25 indicates that the commodity or service is offered at a special price.

The processing in step S95 and subsequent steps is the same as the processing in step S50 and subsequent steps shown in FIG. 4, and will not be described.

In this manner, the e-commerce support apparatus 30 can set a time period for which a commodity or service is offered at a special price. The e-commerce support system 10 can thus contribute to promoting sales.

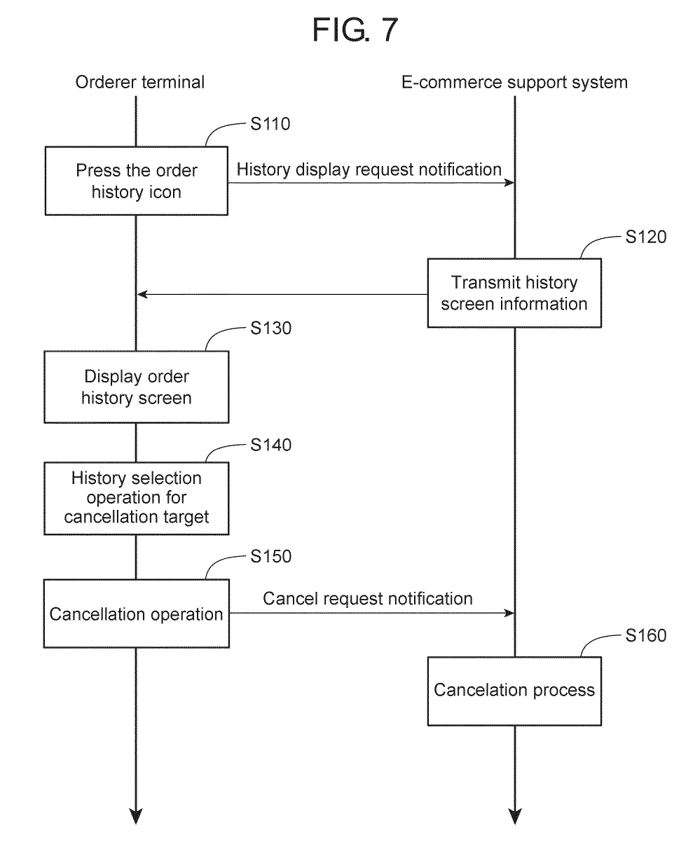

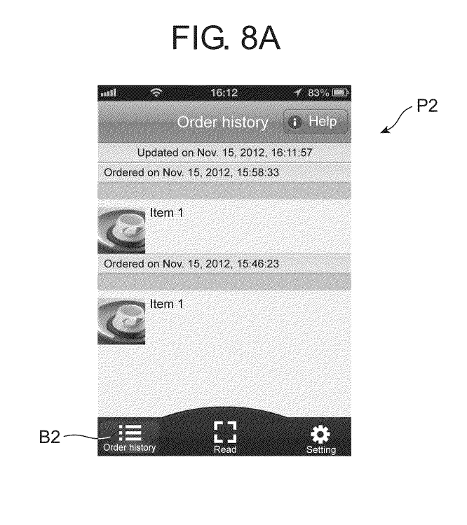

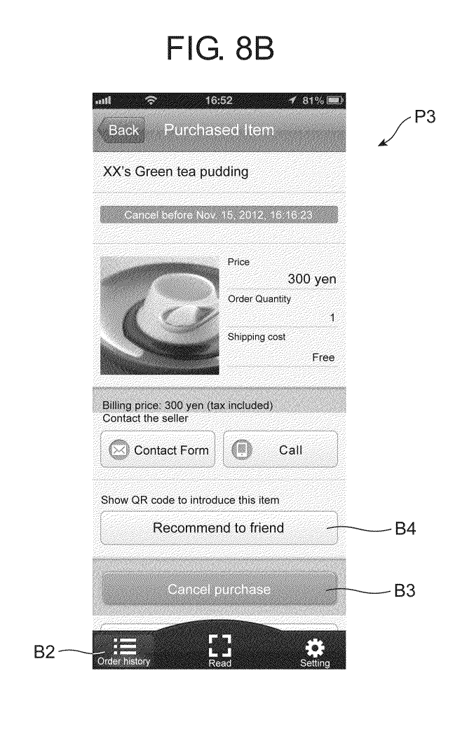

The operation performed using an order history screen listing commodities or services ordered by the orderer will now be described with reference to FIGS. 7, 8A, and 8B.

To see the history of ordered commodities or services, the orderer performs a button pressing operation, or taps the order history icon appearing on the display screen. In response to this operation, the request notification unit 24 transmits a history screen request notification to the e-commerce support apparatus 30 (step S110).

In the e-commerce support apparatus 30, the history management unit 33 reads order history information from the storage unit 39 in response to the history display request notification from the orderer terminal 20, and transmits history screen information listing the order history information to the orderer terminal 20 (step S120).

In the orderer terminal 20, the viewer unit 23 receives the history screen information transmitted from the e-commerce support apparatus 30 and displays the received information on the display unit 25 (step S130). FIG. 8A shows an order history screen that is based on the history screen information displayed on the display unit 25.

FIG. 8A shows an order history screen P2 showing two orders placed for a commodity, which is a pudding. The order history screen P2 shown in FIG. 8A includes an order history icon B2 at the bottom. The screen in FIG. 8A shows a message indicating that the two orders for the pudding can be cancelled.

The ordered commodity or service can be cancelled within a predetermined period after the order (e.g., within 30 minutes). The orderer sees the message in the order history screen P2 on the display unit 25 indicating that the order can be cancelled. The orderer then performs a history selection operation by tapping the touch panel, which is the input unit 26, to select a commodity or service to be cancelled, among the commodities or services listed by the order history information. This history selection operation causes a cancellation screen to appear on the display unit 25 (step S140). FIG. 8B shows the operational screen appearing on the display unit 25.

An operational screen P3 shown in FIG. 8B includes a “Cancel Purchase” button B3. To perform a cancelling operation, the orderer taps the “Cancel Purchase” button B3 to cause the request notification unit 24 to transmit a cancel request notification to the e-commerce support apparatus 30, together with commodity-service ID information identifying the pudding and orderer ID information identifying the orderer (step S150).

The e-commerce support apparatus 30 suspends the order entry process and the payment process in step S60 shown in FIG. 4 for the ordered commodity or service within the cancellation period. In response to the cancel request notification from the orderer terminal 20, the order processing unit 34 cancels the suspended order entry process and the suspended payment process for the pudding identified by the commodity-service ID information based on the order information used for the order identified by the orderer ID information (step S160).

The commodity or service once ordered by the orderer can be easily cancelled within the predetermined period after the order.

In an example described below, the orderer recommends an ordered commodity or service to a family member, a friend, or an acquaintance. The operational screen P3 shown in FIG. 8B includes a “Recommend to Friend” button B4. The orderer taps this button B4. The request notification unit 24 in the orderer terminal 20 then transmits an optically-readable information request notification to the e-commerce support apparatus 30, together with commodity-service ID information identifying the pudding and orderer ID information identifying the orderer.

In the e-commerce support apparatus 30, the history management unit 33 reads commodity-service information from the storage unit 39 based on the commodity-service ID information, and transmits barcode information including the commodity-service ID information to the orderer terminal 20.

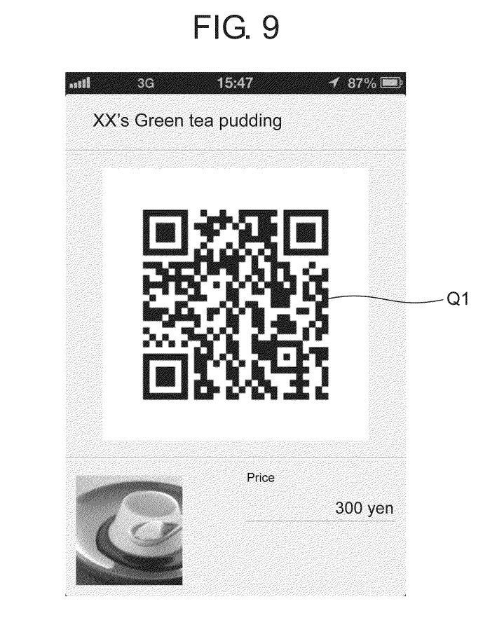

In the orderer terminal 20, the optical information generation unit 27 displays the two-dimensional barcode Q1, which is an image pattern representing the barcode information, on the display unit 25 as shown in FIG. 9.

The orderer may show the two-dimensional barcode Q1 appearing on the display unit 25 to an acquaintance, who may then read the two-dimensional barcode Q1 by operating his or her orderer terminal 20. This allows the acquaintance to order the same pudding as ordered by the orderer by following the procedure shown in FIG. 4. In this manner, the orderer can easily recommend his or her ordered commodity or service to friends, acquaintances, or family members.

The history management unit 33 transmits the commodity-service ID information updated from the commodity-service ID information indicated by the two-dimensional barcode Q, or from the commodity-service ID information initially read by the orderer from the fryer C, to the orderer terminal 20. The updated information enables the two-dimensional barcode to be identified as either having been read from the fryer or the poster created by the seller, or from the barcode displayed by the orderer terminal 20. For example, the commodity-service ID information may have a specific flag set on, or may have information about the counted number of times the barcode has been transmitted between different orderers. The updated commodity-service ID information also enables analysis of the impact from personal communication. The optical information generation unit 36 neither generates a two-dimensional barcode nor transmits image data for the barcode. Instead, the history management unit 33 reads and transmits the commodity-service information. This reduces the amount of data to be communicated.

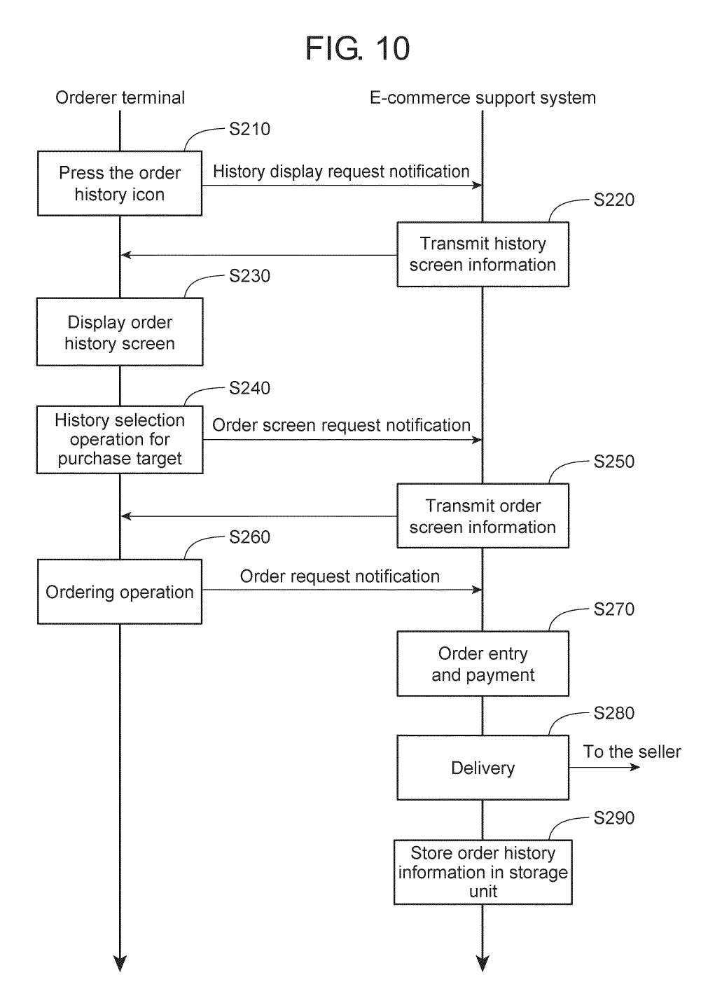

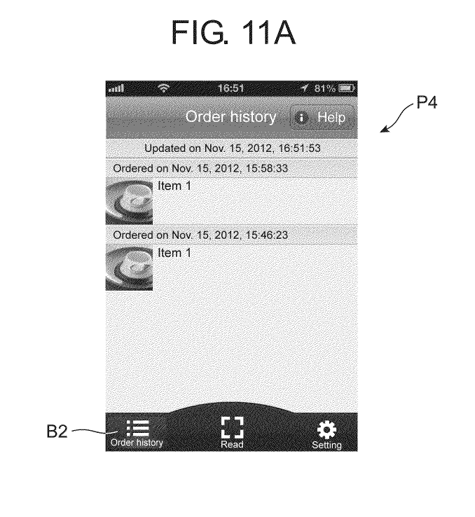

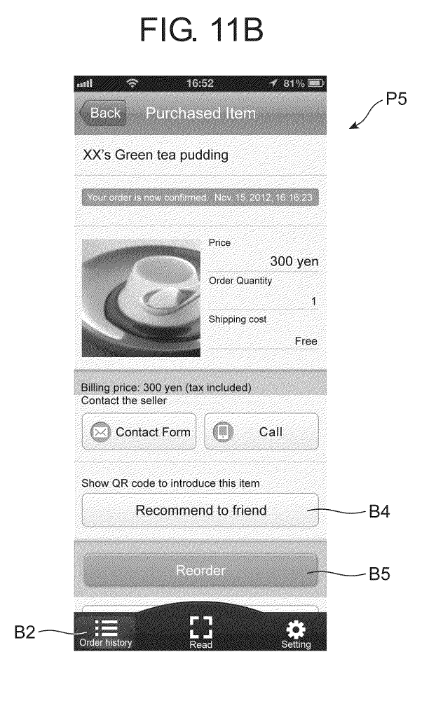

In FIG. 8A, the orderer terminal 20 displays the order history screen for the order cancellation period after the order. The order history screen P2 includes a message indicating that the order can be canceled. When the orderer performs a history selection operation within this cancellation period, the operational screen P3 shown in FIG. 8B appears. However, when the order history icon B2 is tapped after the cancellation period, an order history screen P4 shown in FIG. 11A appears (the procedure in steps S210 to S230 shown in FIG. 10). The order history screen P4 shown in FIG. 11A includes no message indicating that the order can be canceled, unlike in the order history screen P2 shown in FIG. 8A.

The orderer sees the order history screen P4 appearing on the display unit 25, and may intend to reorder the previously ordered commodity or service. In this case, the orderer performs a history selection operation, or selects an intended order from orders listed by the order history information by tapping the touch panel of the input unit 26. In response to the history selection operation, the request notification unit 24 transmits the selected order history information to the e-commerce support apparatus 30 as an order screen request notification (step S240).

In the e-commerce support apparatus 30, the screen transmission unit 32 reads the order screen information from the storage unit 39 based on the order history information transmitted from the orderer terminal 20, and transmits the read information to the orderer terminal 20 (step S250).

In response to the history selection operation, an operational screen P5 shown in FIG. 11B appears. The orderer performs an ordering operation, or taps a “Reorder” button B5. In response to this ordering operation, the request notification unit 24 transmits an order request notification to the e-commerce support apparatus 30 (step S260). Subsequently, the payment and delivery processes are performed and the order history is stored into the storage unit 39 in the same manner as the processing in steps S60 to S80 shown in FIG. 4 (steps S270 to S290).

As described above, the orderer can easily reorder items by using the order history screen P4. This enhances convenience for the orderer, and promotes sales for the seller.

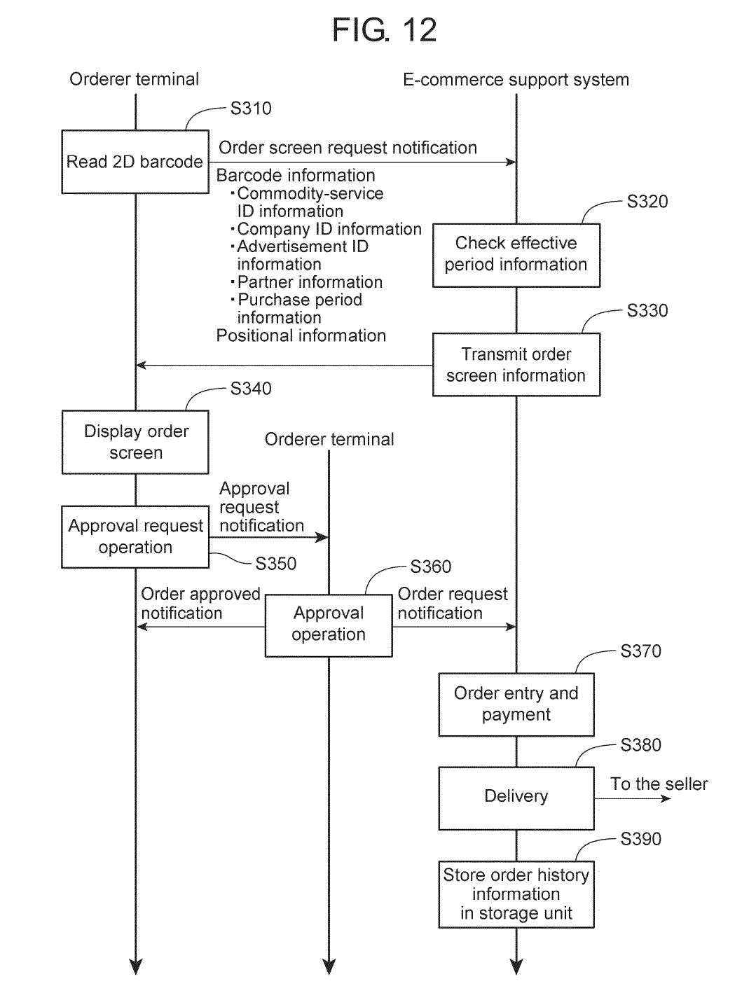

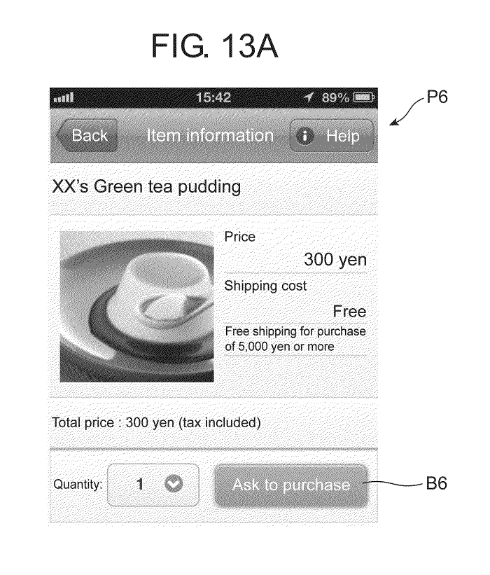

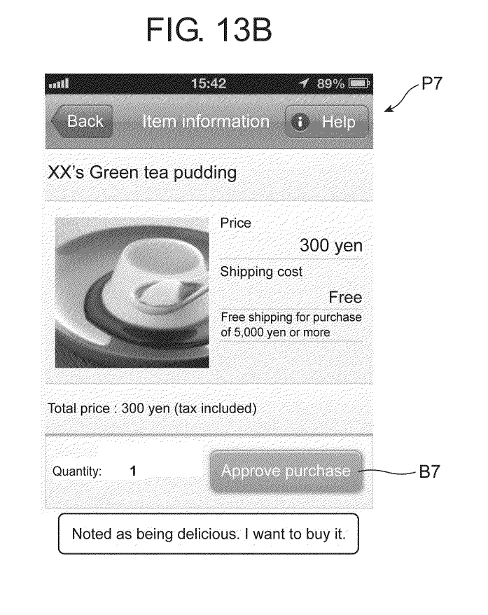

A procedure with which a person unable to make payment with the e-commerce support apparatus 30, or for example a person unable to have a credit card, intends to order a commodity or service will now be described with reference to FIGS. 12, 13A, and 13B.

The processing in steps S310 to S340 shown in FIG. 12 is identical to the processing in steps S10 to S40 shown in FIG. 4, and will not be described.

An order screen P6 used to order a pudding shown in FIG. 13A includes an “Ask to Purchase” button B6 as the order button, instead of the “Purchase” button B1 shown in FIG. 5.

An orderer unable to hold a credit card (e.g., a child) performs an approval request operation, or designates the quantity and then taps the “Ask to Purchase” button B6 on the order screen P6. In response to this approval request operation, the request notification unit 24 included in the orderer terminal 20 (first orderer terminal) transmits an approval request notification to an orderer terminal 20 (second orderer terminal) operated by another orderer who is a credit card holder, or for example a parent of the child (step S350).

The request notification unit 24 may additionally transmit a message from the child to the orderer terminal 20 operated by the parent. In this case, the child can transmit a message indicating the reasons for this order or the situations behind the order.

The orderer terminal 20 operated by the parent displays an approval screen P7 on the display unit 25 as shown in FIG. 13B. The approval screen P7 displays an “Approve Purchase” button B7, which is used to approve the order, together with the message from the child.

When the parent who has received the approval request taps the “Approve Purchase” button B7, the request notification unit 24 transmits an order request notification to the e-commerce support apparatus 30 (step S360). The request notification unit 24 also transmits an approval notification indicating that the order has been approved and entered from the orderer terminal 20 operated by the parent to the orderer terminal 20 operated by the child.

The e-commerce support apparatus 30 performs the payment and delivery processes and stores the order history into the storage unit 39 in the same manner as the processing in steps S60 to S80 shown in FIG. 4 (steps S370 to S390).

As described above, a request for payment can be transmitted from a person unable to make payment of e-commerce to a person able to make the payment. This widens the range of orderers, and thus increases the sales of commodities or services further.

In the above example described with reference to FIGS. 12, 13A, and 13B, the orderer is a child unable to hold a credit card, and the child acquires an approval from his or her parent to order a commodity or service. The e-commerce support system 10 can be used in any other cases in which payment is requested from a person unable to make payment for purchase of a commodity or service to a person able to make such payment.

For example, the e-commerce support system 10 may be used at companies. For example, the e-commerce support system 10 may be used when a worker at a branch office unable to make payment for purchase of office equipment, such as stationaries, office supplies, or computers, may request purchase of such equipment to a payment department at a head office.

In this manner, the e-commerce support system 10 is also useful between organizations, as well as between individuals.

As described above, the e-commerce support system 10 according to the present embodiment reads commodity-service ID information from a two-dimensional barcode Q appearing on an advertisement medium by operating the orderer terminal 20, and transmits the read information to the address of the e-commerce support apparatus 30 in the network. This enables the orderer to order a commodity or service based on the order screen information, and eliminates the complicated operation of, for example, placing an intended item into a cart and settling the payment.

The orderer terminal 20 transmits the commodity-service ID information read from the two-dimensional barcode Q to the address of the e-commerce support apparatus 30 in the network set in the orderer terminal 20. This further eliminates another complicated operation of the orderer for tapping the screen containing the URL indicated by the two-dimensional barcode Q.

In the e-commerce support system 10, the e-commerce support apparatus 30 installed at the e-commerce operator performs the payment process. This allows a website operated by the seller to eliminate the payment processing capability and to simply contain pages introducing commodities and services.

Although the orderer purchases a pudding sold by the seller in the above embodiment described with reference to FIGS. 4 to 13A, and 13B, the e-commerce support system 10 may be used to request brochures, instead of commodities for sale.

For example, the orderer terminal 20 may read a two-dimensional barcode appearing on a fryer or a poster placed at a store, where digital cameras are sold. The e-commerce support apparatus 30 transmits an order screen for requesting a brochure indicated by commodity-service ID information to the orderer terminal 20.

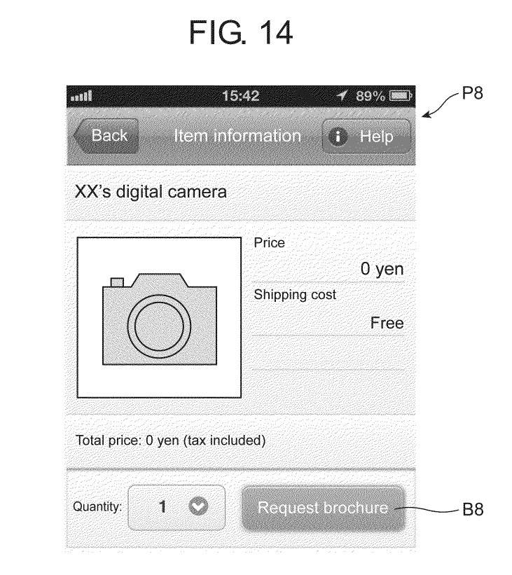

An order screen P8 shown in FIG. 14 includes an image of a digital camera and its price of 0 yen, and displays a “Request Brochure” button B8, instead of the “Purchase” button B1 (refer to FIG. 5).

The orderer taps the “Request Brochure” button B8 to cause the orderer terminal 20 to transmit an order request notification to the e-commerce support apparatus 30. The e-commerce support apparatus 30 then transmits, to the seller, an e-mail message indicating that the order processing unit 34 has entered the order for the brochure.

In this manner, the e-commerce support system 10 can provide items that are not commodities to the orderer. This enhances convenience for the orderer.

Although the orderer requests a free item, or a brochure, in the above example described with reference to FIG. 14, the orderer may request opening of an account with a banking organization based on personal information registered with the e-commerce support apparatus 30. The registered information may include information needed to open an account, such as company information, school information, and company or school contact address information, in addition to information about the orderer's name, address, phone number, delivery address, payment information, and e-mail address.

The e-commerce support system 10 may further be used for making reservations, instead of requesting brochures. For example, the e-commerce support system 10 may be used to reserve tickets for lectures, stage performance, and concerts, tickets for railroads and airplanes, and hotel rooms, or for any other reservations.

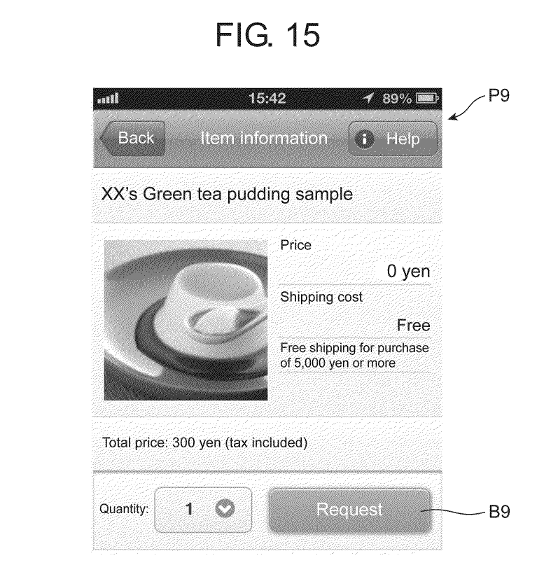

Although a free brochure is ordered in the example described with reference to FIG. 14 and a free sample is ordered as described with reference to FIG. 15, the e-commerce operator may provide a prize to the orderer with the same method as described above.

For example, the orderer terminal 20 reads a two-dimensional barcode appearing on a magazine or a fryer containing information about prizes. In response to this operation, the e-commerce support apparatus 30 provides an order screen corresponding to a prize indicated by commodity-service ID information to the orderer terminal 20.

An order screen for a prize displays a “Participate” button, instead of the “Request Brochure” button B8 in the order screen P8 shown in FIG. 14.

The orderer taps the “Participate” button appearing on the orderer terminal 20. In response to this operation, the orderer terminal 20 transmits an order request notification to the e-commerce support apparatus 30. In the e-commerce support apparatus 30, the order processing unit 34 performs an order entry process, and notifies the provider of the prize that the orderer has participated in the prize competition.

Using such two-dimensional barcode on a magazine or a fryer carrying commodity-service ID information for a prize, the e-commerce support system 10 can provide the prize to the orderer.

In an example described below, a free sample is ordered.

The orderer operates the orderer terminal 20 to read a two-dimensional barcode appearing on a website, a brochure, or a fryer provided by a seller engaged in a campaign for providing samples. In response to this operation, the e-commerce support apparatus 30 transmits an order screen for providing a sample identified by commodity-service ID information to the orderer terminal 20.

An order screen P9 shown in FIG. 15 displays an image of a sample, which is a pudding, with a price of 0 yen. The order screen P9 displays a “Request Sample” button B9, instead of the “Purchase” button B1 (refer to FIG. 5).

The orderer taps the “Request Sample” button B9 to cause the orderer terminal 20 to transmit an order request notification to the e-commerce support apparatus 30. In the e-commerce support apparatus 30, the order processing unit 34 performs an order entry process, and transmits an e-mail message indicating that the sample of the pudding has been requested to the seller.

In this manner, the e-commerce support system 10 can provide free items to the orderer, and thus enhances convenience for the orderer.

If the orderer who has tried the sample of the pudding likes the pudding and intends to purchase the item, the orderer displays the order history screen P4 shown in FIG. 11A on the display unit 25. The orderer then selects the pudding that he or she has tried as a sample by performing a history selection operation. In response to the history selection operation, the e-commerce support apparatus 30 transmits the operational screen P5 shown in FIG. 11B.

When the sample is requested, the e-commerce support apparatus 30 associates commodity-service ID information, which identifies the sample, with orderer ID information, which identifies the orderer associated with the order history information. The e-commerce support apparatus 30 uses the order history information to determine that the orderer who has previously requested the sample now places the second or subsequent orders. Thus, when the history management unit 33 transmits the order history information to the orderer terminal 20, the history management unit 33 transmits commodity-service information indicating a paid item to be sold, instead of commodity-service information indicating a sample.

The orderer taps the “Reorder” button B5 on the operational screen P5 shown in FIG. 11B to purchase the pudding as a commodity but not as a sample with the procedure in steps S270 to S290 shown in FIG. 10.

In an example described below, a set of samples are provided.

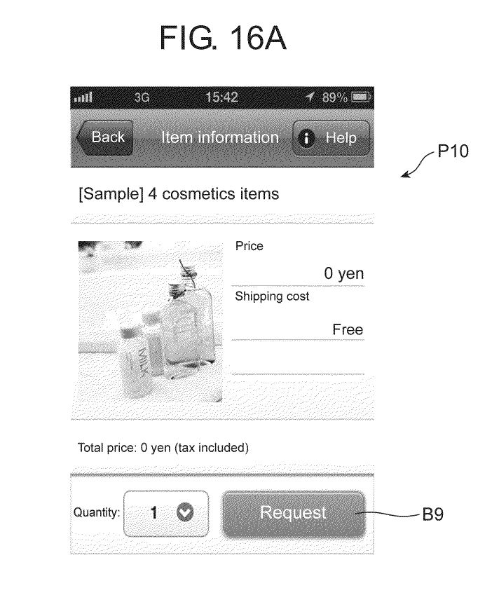

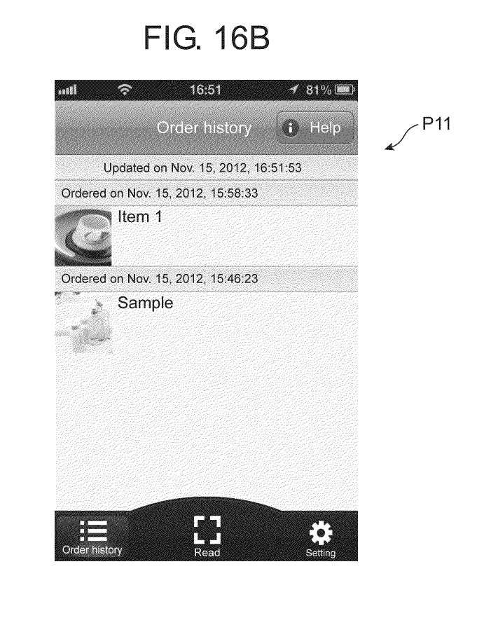

The orderer sees a fryer showing a set of four items of cosmetics as samples, and intends to try these samples. The orderer reads the two-dimensional barcode on the fryer, and displays an order screen P10 shown in FIG. 16A for ordering samples on the orderer terminal 20. The orderer then taps the “Request Sample” button B9 to obtain the samples. If the orderer who has tried the set of four samples likes these items of cosmetics and intends to purchase these items, the orderer displays an order history screen P11 shown in FIG. 16B on the display unit 25. The order history screen P11 in FIG. 16B shows the orders that have been confirmed after the cancellation period.

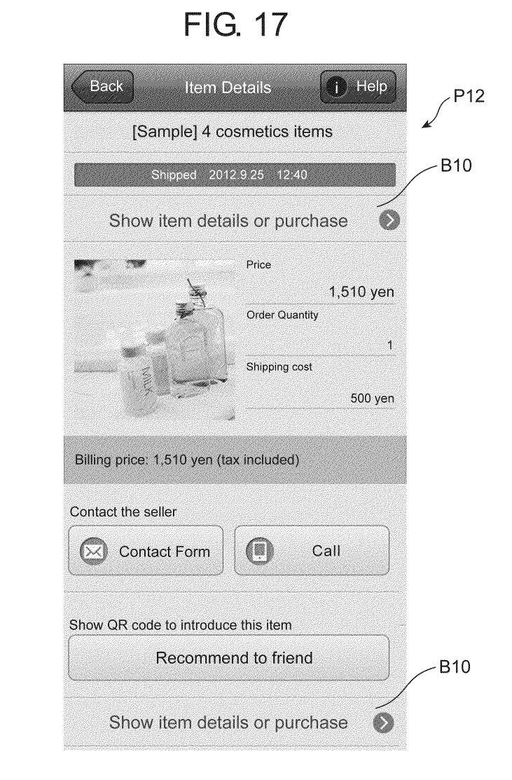

The orderer selects the set of four items of cosmetics that have been previously ordered as samples from the history selection operation. In response to this, the e-commerce support apparatus 30 transmits an operational screen. An operational screen P12 shown in FIG. 17 includes a button B10 to “Show item details or purchase.” The orderer taps this “Details” button B10 to cause the request notification unit 24 to transmit a list request notification to the e-commerce support apparatus 30.

In the e-commerce support apparatus 30, the history management unit 33 transmits list display information indicating a list display screen in response to the list request notification from the orderer terminal 20.

When the sample is requested, the orderer ID information identifying the orderer included in the order history information is associated with the commodity-service ID information identifying the sample. The history management unit 33 uses the order history information to determine that the orderer who has previously requested the sample now places the second or subsequent orders. Thus, when the history management unit 33 transmits the list display information to the orderer terminal 20, the history management unit 33 transmits commodity-service information indicating a paid item, instead of transmitting the commodity-service information indicating a sample.

The commodity-service ID information for each sample is associated with commodity-service information of the corresponding commodity for sale and is stored into the storage unit 39. Thus, when the history management unit 33 transmits the list display information to the orderer terminal 20, the history management unit 33 transmits commodity-service information for each individual commodity, instead of transmitting the commodity-service information for the set of samples.

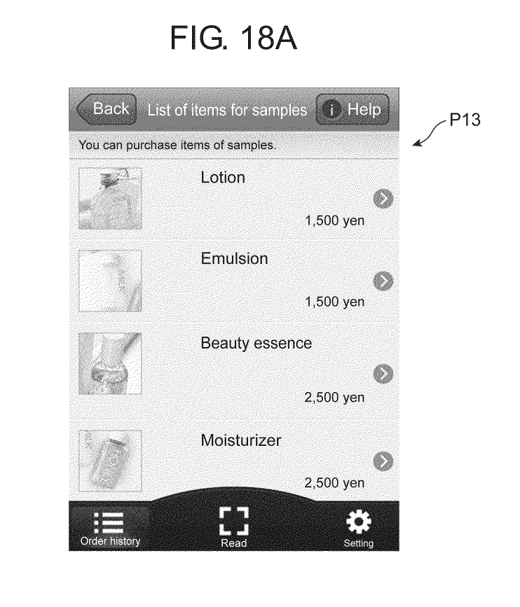

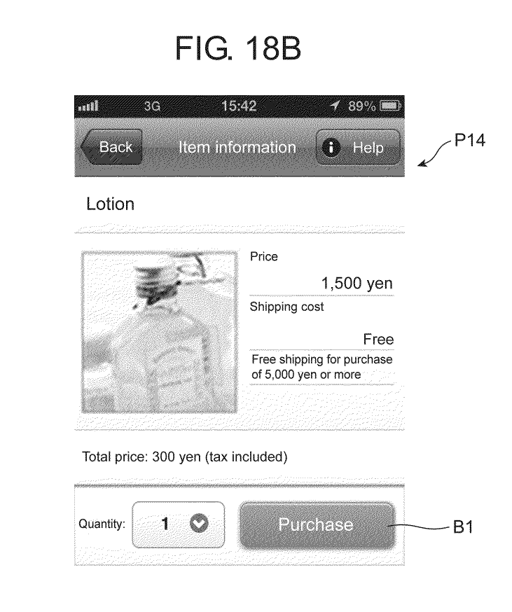

FIG. 18A shows a list display screen P13. The list display screen P13 lists four sample items of cosmetics provided in the set, which are a lotion, an emulsion, a beauty essence, and a moisturizer.

The orderer selects an intended item of cosmetics from the list display screen P13 by performing a list selection operation. In response to this operation, the request notification unit 24 transmits, as an order screen request notification, order history information indicating the selected order to the e-commerce support apparatus 30.

In the e-commerce support apparatus 30, the screen transmission unit 32 reads order screen information from the storage unit 39 based on the order history information transmitted from the orderer terminal 20, and transmits the read information to the orderer terminal 20.

An order screen P14 shown in FIG. 18B then appears. The orderer performs an ordering operation, or taps the “Purchase” button B1. In response to the ordering operation, the request notification unit 24 transmits an order request notification to the e-commerce support apparatus 30. Subsequently, the payment and delivery processes are performed and the order history is stored into the storage unit 39 in the same manner as the processing in steps S60 to S80 shown in FIG. 4.

As described above, the orderer who has ordered a set of samples can subsequently order one or more of the items separately using a list of separate paid items of the sample set.

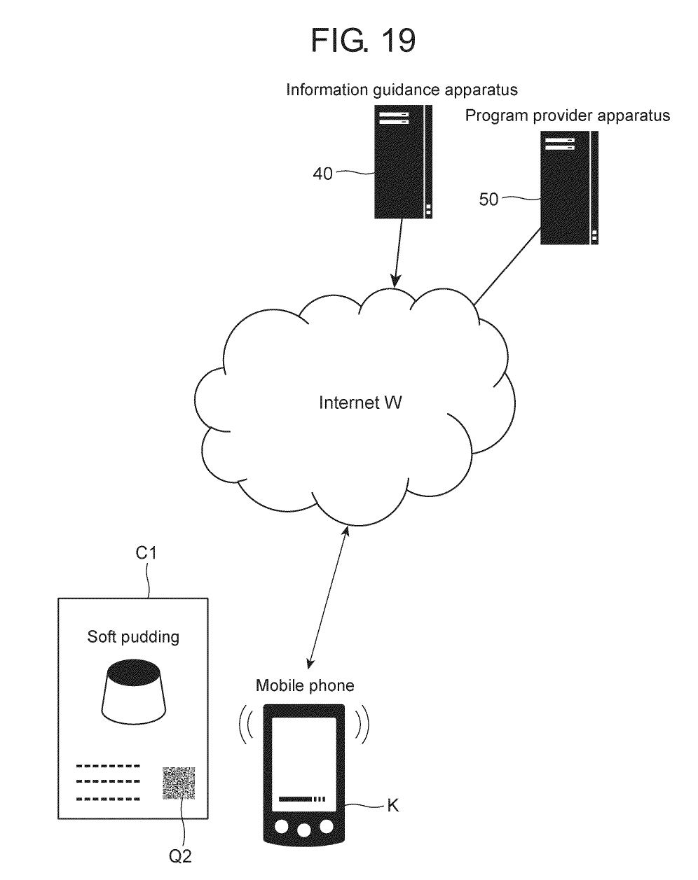

In an example described below with reference to FIGS. 19 to 22, an orderer program has yet to be installed on a mobile phone, which is a smartphone functioning as the orderer terminal 20.

The mobile phone is capable of reading a two-dimensional barcode and accessing the Internet using a URL included in the read two-dimensional barcode.

As shown in FIG. 19, a fryer C1, which is an advertising medium, contains a two-dimensional barcode Q2, which carries barcode information including an address in a network as well as commodity-service ID information, company ID information, advertisement ID information, and partner information.

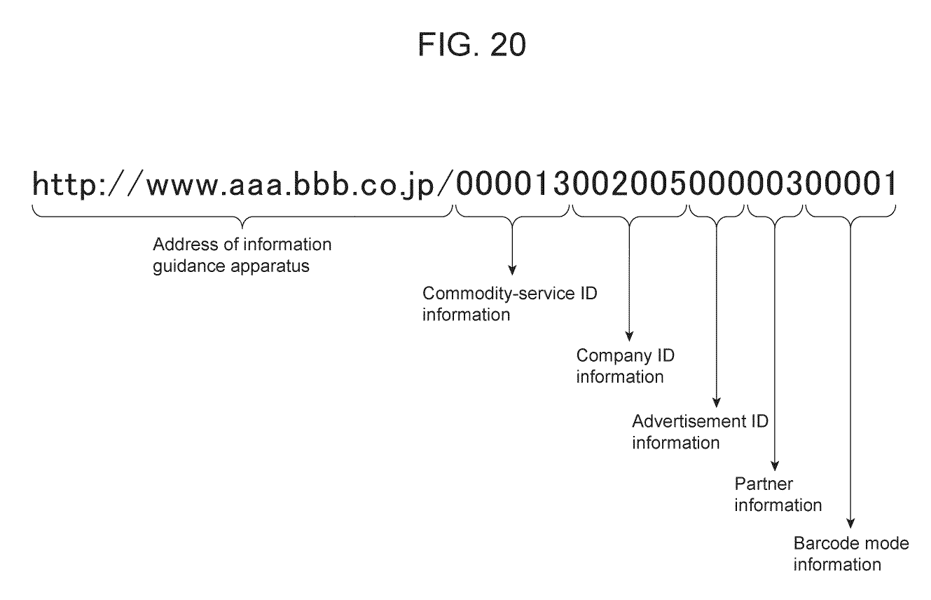

The address in the network is a URL indicating a website operated by an e-commerce operator. FIG. 20 shows one example of such barcode information.

As shown in FIG. 20, the barcode information includes a URL indicating a website operated by an e-commerce operator, which is followed by commodity-service ID information (6 digits), company ID information (6 digits), advertisement ID information (3 digits), partner information (3 digits), and barcode mode information (4 digits). The URL included in the barcode information differs from the address of the e-commerce support apparatus 30 in the network to which the reader unit 22 included in the orderer terminal 20 transmits barcode information.

The website operated by the e-commerce operator will now be described with reference to FIG. 19.

As shown in FIG. 19, the website operated by the e-commerce operator is provided by the information guidance apparatus 40.

Through the Internet W, the information guidance apparatus 40 is connected to a mobile phone K, as well as to a program provider apparatus 50, which provides an installation program for an orderer program.

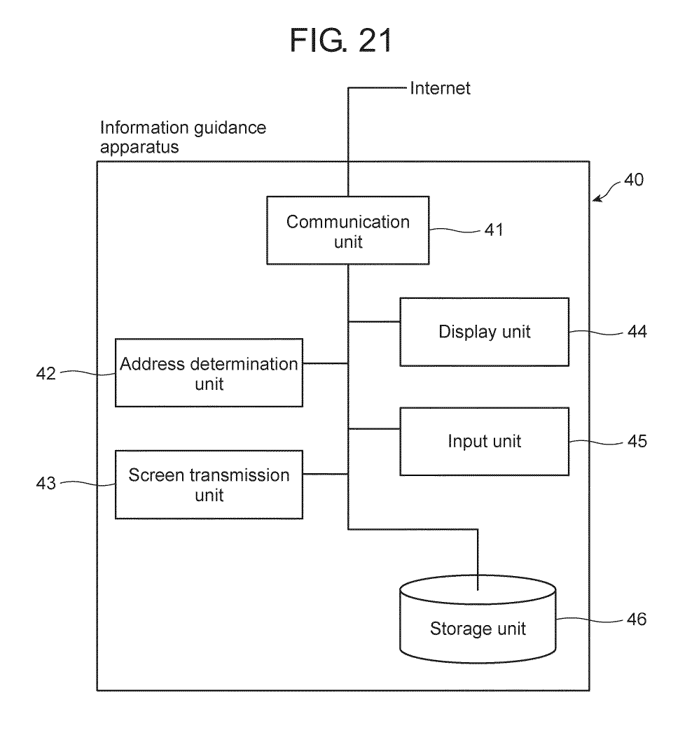

As shown in FIG. 21, the information guidance apparatus 40 includes a communication unit 41, an address determination unit 42, a screen transmission unit 43, a display unit 44, an input unit 45, and a storage unit 46.

The communication unit 41 outputs transmission data to the Internet W or receives input reception data from the Internet W.

The address determination unit 42 provides the screen transmission unit 43 with an instruction to transmit display screen information to the mobile phone K based on an access address from the mobile phone K.

The screen transmission unit 43 reads display screen information from the storage unit 46 in accordance with the instruction to transmit the display screen information provided from the address determination unit 42, and transmits the read information to the mobile phone K.

The display unit 44 and the input unit 45 are identical to the display unit 37 and the input unit 38 included in the e-commerce support apparatus 30, and will not be described.

The storage unit 46 stores display screen information including a descriptive page describing the e-commerce support system, a guidance page containing information about guidance for the installation program, an application page used to apply for a seller, and an application page used to apply for a partner company.

As shown in FIG. 19, when the mobile phone K on which no orderer program has been installed reads a two-dimensional code, or an image pattern representing barcode information, the mobile phone K recognizes the entire barcode information including the URL followed by various other items of information as a single URL. The mobile phone K then accesses the information guidance apparatus 40, which provides the website operated by the e-commerce operator, through the Internet W.

In the information guidance apparatus 40, the address determination unit 42 performs determination about the access address. In one example, another user operating a personal computer accesses http://www.aaa.bbb.co.jp/, which indicates a route to the website operated by the e-commerce operator. In this case, the address determination unit 42 provides the screen transmission unit 43 with an instruction to transmit the descriptive page, which is the top page.

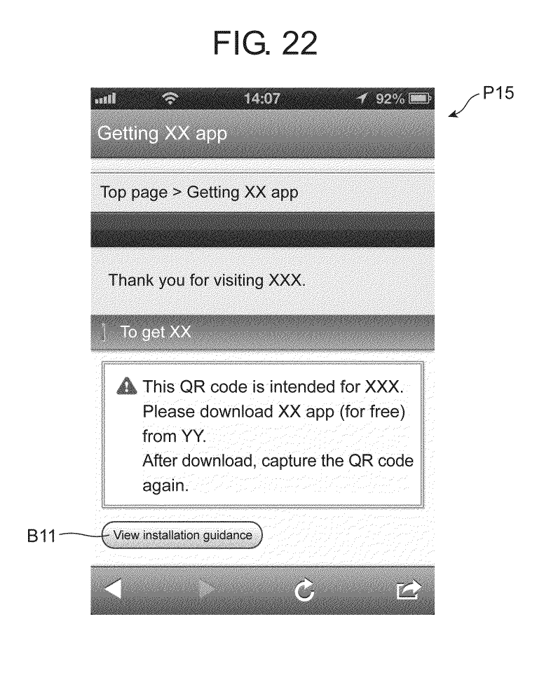

In another example, the mobile phone K reads the two-dimensional barcode Q2 on the fryer C to access http://www.aaa.bbb.co.jp/0000130020050000030001 indicated by the barcode information. This address includes the address indicating a route to the website operated by the e-commerce operator, and additionally includes an address part not found in the website, which is specifically the barcode information including commodity-service ID information. In this case, the address determination unit 42 provides the screen transmission unit 43 with an instruction to transmit the guidance screen P for the installation program shown in FIG. 22.

Based on the instruction provided from the address determination unit 42, the screen transmission unit 43 reads display screen information from the storage unit 46, and transmits the read information to the personal computer or the mobile phone K operated by the other user who has accessed the address.

A guidance screen P15 showing the guidance page for the installation program shown in FIG. 22 includes a message indicating that the two-dimensional barcode is intended for the e-commerce support system according to the present embodiment. The guidance screen P15 further includes a “Guide Installation” button B11, which is used to access the program provider apparatus 50 providing the installation program.

When the user of the mobile phone K operates the mobile phone K and presses the “Guide Installation” button B11, the mobile phone K accesses the program provider apparatus 50 to download the installation program for installing the orderer program. This allows the mobile phone user to install the orderer program onto the mobile phone K to enable the mobile phone K to function as the orderer terminal 20.

The mobile phone K on which no orderer program has been installed may be used to read the two-dimensional barcode Q2 on the fryer C. The two-dimensional barcode Q2 contains the URL at which the orderer program can be provided to the mobile phone K. This allows the orderer program to be easily obtained and installed on the mobile phone K.

The commodity-service ID information, the company ID information, the advertisement ID information, and the partner information are included as a part of the URL at which the orderer program is to be provided. The e-commerce support apparatus 30 can easily determine whether the address has been accessed by reading the two-dimensional barcode Q2 under the orderer program operating on the orderer terminal by determining whether the address is found in the website operated by the e-commerce operator.

When the reader unit 22 in the mobile phone K on which the orderer program has been installed (that is, the orderer terminal 20) reads the two-dimensional barcode, the barcode mode information using the four digits of the barcode information can be used to determine the mode of the two-dimensional barcode. In the example of FIG. 20, the barcode ID information is 0001, indicating that the barcode information excluding the URL includes 6 digits carrying the commodity-service ID information, 6 digits carrying the company ID information, 3 digits carrying the advertisement ID information, 3 digits carrying the partner information, and 4 digits carrying the barcode mode information.

The reader unit 22 reads the information carried by the lower 22 digits, and excludes the URL.

The reader unit 22 then transmits the read information to the address of the e-commerce support apparatus 30 in the network, which differs from the URL indicated by the barcode information.

In this manner, the number of digits constituting the barcode information excluding the URL is determined. The lower digits of the information excluding the URL are then extracted. As a result, the orderer terminal 20 can access the e-commerce support apparatus 30 when the barcode information includes the URL for providing guidance about the orderer program.

In the present embodiment, the orderer terminal is a mobile phone that is a smartphone. The orderer terminal may be any other device that can read optically-readable information and can access a network. For example, the device may be a tablet terminal or a personal digital assistant (PDA).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### INDUSTRIAL APPLICABILITY

The present invention has applications described below.

The present invention allows various media to function as advertising media on which the seller places optically-readable information. Examples of such advertising media include fryers, posters, billboards, newspapers, magazines, advertising inserts, booklets, brochures, pamphlets, packing boxes, packing sheets, labels, receipts, painted wall surfaces, and websites or commercial videos on displays.

For example, hospitalized patients or aged people in nursing homes may have difficulty in going outside for shopping. An orderer who stays in such a facility may order a commodity printed on a brochure by reading its optically-readable information. The ordered commodity can then be delivered by a store clerk from a drug store or a convenience store as a seller near the facility. This enhances convenience for patients or for the aged people.

Printed matter can show optically-readable information. Sheets on which photographs of commodities and optically-readable information are printed may replace the commodities arranged on shelves at a store. An orderer may come to the store and read optically-readable information to order commodities. This eliminates a stock of commodities kept at a store, and enables effective use of the store space.

Whereas ordering from home with a brochure eliminates the need to go to a store, ordering at the store will create a regional community there. This system is suitable for stores in urban areas with less neighbor ties or for stores in cities or villages with a high ratio of aged people who tend to go out less often.

### REFERENCE SIGNS LIST

10 e-commerce support system
20 orderer terminal
21 wireless unit
22 reader unit
23 viewer unit
24 request notification unit
25 display unit
26 input unit
27 optical information generation unit
28 positioning unit
30 e-commerce support apparatus
31 communication unit
32 screen transmission unit
33 history management unit
34 order processing unit
35 registration unit
36 optical information generation unit
37 display unit
38 input unit
39 storage unit
40 information guidance apparatus
41 communication unit
42 address determination unit
43 screen transmission unit
44 display unit
45 input unit
46 storage unit
50 program provider apparatus
P1 order screen
P2 order history screen
P3 operational screen
P4 order history screen
P5 operational screen
P6 order screen
P7 approval screen
P8 order screen
P9 order screen
P10 order screen
P11 order history screen
P12 operational screen
P13 list display screen
P14 order screen
B1 “Purchase” button
B2 order history icon
B3 “Cancel Purchase” button
B4 “Recommend to Friend” button
B5 “Reorder” button
B6 “Ask to Purchase” button
B7 “Approve Purchase” button
B8 “Brochure Request” button
B9 “Participate” button
B10 “Details” button
B11 “Guide Installation” button
C, C1 fryer
Q, Q1 two-dimensional barcode
W Internet
K mobile phone

1. An e-commerce support system comprising an orderer terminal operable by an orderer and an e-commerce support apparatus, the orderer terminal and the e-commerce support apparatus being connected with a network,
the orderer terminal including
a reader unit that reads commodity-service ID information from optically-readable information appearing on an advertising medium, and transmits, together with orderer ID information, the commodity-service ID information to a network address indicating the e-commerce support apparatus in the network, the commodity-service ID information identifying a commodity or service, the orderer ID information identifying the orderer who operates the orderer terminal, the network address being set in the orderer terminal,
a viewer unit that receives order screen information transmitted from the e-commerce support apparatus based on the commodity-service ID information, and displays the order screen information on a display unit, and
a request notification unit that transmits an order request notification to the e-commerce support apparatus in response to an ordering operation that is performed with an input unit using the order screen information on the display unit,
the e-commerce support apparatus including
a storage unit storing the order screen information associated with the commodity-service ID information,
a screen transmission unit that reads the order screen information from the storage unit based on the commodity-service ID information transmitted from the orderer terminal, and transmits the order screen information to the orderer terminal, and
an order processing unit that enters an order for the commodity or service identified by the commodity-service ID information in accordance with the order request notification transmitted from the orderer terminal.

2. The e-commerce support system according to claim 1,
wherein the e-commerce support apparatus further includes
a history management unit that stores, as order history information, the commodity-service ID information indicating the commodity or service ordered with the order request notification transmitted from the orderer terminal into the storage unit, and reads the order history information from the storage unit in accordance with a request to display a history transmitted from the orderer terminal, and transmits history screen information listing the order history information to the orderer terminal; and
wherein the viewer unit in the orderer terminal receives the history screen information from the e-commerce support apparatus and displays an order history screen showing the received history screen information on the display unit.

3. The e-commerce support system according to claim 2, wherein
the request notification unit in the orderer terminal transmits an order request notification to the e-commerce support apparatus in response to a history selection operation that is performed with the input unit using the history screen information on the display unit and an ordering operation that is performed using the order history information selected by the history selection operation.

4. The e-commerce support system according to claim 2, wherein
the orderer terminal further includes
an optical information generation unit that displays optically-readable information on the display unit based on commodity-service ID information included in the order history information transmitted from the history management unit.

5. The e-commerce support system according to claim 4, wherein
when the history management unit in the e-commerce support apparatus transmits the order history information to the orderer terminal, the history management unit uses, as the order history information, commodity-service ID information updated from the commodity-service ID information used when the order is placed.

6. The e-commerce support system according to claim 3, wherein
when the history selection operation performed with the input unit using the history screen information indicates a sample, the history management unit in the e-commerce support apparatus transmits commodity-service ID information indicating that the commodity or service is a paid item based on the commodity-service ID information used when the order is placed.

7. The e-commerce support system according to claim 6, wherein
when the history selection operation performed with the input unit using the history screen information indicates a set of samples, the history management unit transmits commodity-service ID information indicating that the commodity or service is one or more of a plurality of paid items corresponding to the samples in the set based on the commodity-service ID information used when the order is placed.

8. The e-commerce support system according to claim 1, wherein
the request notification unit in the orderer terminal transmits an approval request notification indicating a request to order a commodity or service to another orderer terminal in response to an ordering operation that is performed with the input unit using order screen information displayed on the display unit, and transmits an order request notification to the e-commerce support apparatus in response to an ordering operation performed to approve an order for the commodity or service in response to the approval request notification.

9. The e-commerce support system according to claim 1, wherein
the order processing unit in the e-commerce support apparatus reads effective period information indicating an effective period of the order for the commodity or service from the storage unit based on the commodity-service ID information transmitted from the orderer terminal, and notifies the orderer terminal that the order indicated by the order request notification transmitted from the orderer terminal is ineffective when a time and date at which the orderer operating the orderer terminal has attempted to place the order fails to be within the effective period indicated by the effective period information.

10. The e-commerce support system according to claim 1, wherein
the order processing unit in the e-commerce support apparatus reads effective period information indicating a time period for a special price of the commodity or service from the storage unit based on the commodity-service ID information transmitted from the orderer terminal, and
the screen transmission unit reads special price information indicating a special price of the commodity or service from the storage unit based on the commodity-service ID information, and transmits order screen information including the special price corresponding to the commodity-service ID information to the orderer terminal when a time and date at which the orderer operating the orderer terminal has attempted to place the order is within the time period indicated by the effective period information.

11. The e-commerce support system according to claim 1, wherein
the e-commerce support apparatus further includes
an optical information generation unit that generates optically-readable information to appear on an advertising medium based on the commodity-service ID information in such a manner that the optically-readable information includes medium ID information for identifying the advertising medium.

12. An e-commerce support method implemented by an orderer terminal and an e-commerce support apparatus that are connected with a network, the method comprising:
reading, with a reader unit in the orderer terminal, commodity-service ID information from optically-readable information appearing on an advertising medium, and transmitting, together with orderer ID information for identifying an orderer who operates the orderer terminal, the commodity-service ID information to a network address indicating the e-commerce support apparatus in the network, the network address being set in the orderer terminal;
reading, with a screen transmission unit in the e-commerce support apparatus, order screen information from a storage unit of the e-commerce support apparatus based on commodity-service ID information transmitted from the orderer terminal, and transmitting the order screen information to the orderer terminal;
receiving, with a viewer unit in the orderer terminal, the order screen information transmitted from the e-commerce support apparatus based on the commodity-service ID information, and displaying the order screen information on a display unit of the orderer terminal;
transmitting, with a request notification unit in the orderer terminal, an order request notification to the e-commerce support apparatus in response to an ordering operation that is performed with an input unit using the order screen information on the display unit; and
entering, with an order processing unit in the e-commerce support apparatus, an order for a commodity or service identified by the commodity-service ID information in accordance with the order request notification transmitted from the orderer terminal.

13. A non-transitory computer-readable advertising medium that stores optically-readable information indicating a network address to be accessed to acquire an orderer program when no orderer program has been installed in the orderer terminal included in the e-commerce support system according to claim 1, the program being installable on a computer to enable the computer to function as:
a reader unit that reads commodity-service ID information from optically-readable information appearing on an advertising medium, and transmits, together with orderer ID information, the commodity-service ID information to a network address indicating the e-commerce support apparatus in the network, the commodity-service ID information identifying a commodity or service, the orderer ID information identifying the orderer who operates the orderer terminal, the network address being set in the orderer terminal,
a viewer unit that receives order screen information transmitted from the e-commerce support apparatus based on the commodity-service ID information, and displays the order screen information on a display unit, and
a request notification unit that transmits an order request notification to the e-commerce support apparatus in response to an ordering operation that is performed with an input unit using the order screen information on the display unit.

14. The advertising medium according to claim 13, wherein
the commodity-service ID information constitutes a part of the network address to be accessed to acquire the orderer program.
